(19) United States
(12) Patent Application Publication
(10) Pub. No.: US 2006/0236801 A1
(43) Pub. Date: Oct. 26, 2006

(54) Electric actuator for a device which is to be actuated

(75) Inventor: Alexander Walter, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: Renk AG, Augsburg (DE)

(21) Appl. No.: 11/407,728

(22) Filed: Apr. 19, 2006

(30) Foreign Application Priority Data
Apr. 20, 2005 (DE) 10 2005 018 259.3

(51) Int. Cl. H02K 7/116

(52) U.S. Cl. 74/421 A

(57) ABSTRACT

An electric actuator for a device which is to be actuated, having an electric-motor drive inputting its drive into a step-up gear mechanism, it being possible for the device to be driven via the step-up gear mechanism, in order to switch the device from a defined position into another defined position. A clutch element is connected after the step-up gear mechanism so that the device which is to be actuated can be driven by the step-up gear mechanism with the clutch element connected in between. The clutch element decouples the step-up gear mechanism from the device in the event of a failure of the current supply or voltage supply for the actuator, with the result that a defined basic position or rest position can be assumed automatically by the device which is to be actuated.

### BACKGROUND OF THE INVENTION

1. Field of the Invention

The invention relates to an electric actuator for a device which is to be switched between defined positions, including an electric motor drive and a step-up gear mechanism which increases the torque and reduces the rotational speed output by the motor.

2. Description of the Related Art

Electric actuators for actuating or adjusting devices which are to be actuated are known from the prior art, which electric actuators, in addition to an electric-motor drive which rotates at a high speed, have a step-up gear mechanism which is connected after the drive. With the aid of this mechanism, the high rotational speeds of the electric-motor drive can be stepped up to large torques and low rotational speeds in order to actuate the device which is to be actuated. Electric actuators of this type have the advantage that they have small dimensions and a low weight and accordingly can be designed with a small overall shape. Accordingly, in applications in which the overall size of an electric actuator is a decisive criterion, electric actuators comprising a rotary, electric-motor drive with a step-up gear mechanism connected after it are usually used.

In many applications, in particular in motor vehicles, it is necessary for a device which is to be actuated to assume a defined position, for example a rest position or basic position, or to return to the latter in the event of a failure of the current supply or the voltage supply for the actuator. In electric actuators of this type, the electric-motor drive of which has a step-up gear mechanism connected after it, the step-up gear mechanism frequently causes locking or blocking, however, as a consequence of friction, with the result that the device which is to be actuated cannot return into a defined position in the event of a failure of the current supply or voltage supply for the actuator.

Since the return of the device to be actuated into a defined position is a compulsory requirement in many applications, there is a need for electric actuators of this type which permit the return of the device to be actuated into a defined position in the event of a failure of the current supply or voltage supply for the actuator.

### SUMMARY OF THE INVENTION

Proceeding from this, the present invention is based on the problem of providing a novel electric actuator for a device which is to be actuated.

The actuator according to the invention includes a clutch element which is connected after the step-up gear mechanism in such a way that the device which is to be actuated can be driven by the step-up gear mechanism with the clutch element connected in between. The clutch element decouples the step-up gear mechanism from the device which is to be actuated in the event of a failure of the current supply or voltage supply for the actuator, with the result that a defined basic position or rest position can be assumed automatically by the device which is to be actuated.

In the context of the present invention, an electric actuator for a device which is to be actuated is proposed, which electric actuator, in addition to an electric drive and a step-up gear mechanism, includes a clutch element which is connected after the step-up gear mechanism. The electric-motor drive inputs its drive into the step-up gear mechanism, and the step-up gear mechanism inputs its drive via the clutch element into the device which is to be actuated. In the event of a failure of the current supply or voltage supply for the actuator, the clutch element opens and decouples the step-up gear mechanism from the device which is to be actuated, with the result that the device can assume the defined basic position or rest position.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a diagram of an arrangement including an actuator according to the invention and a device which is to be actuated;

FIG. 2 shows a detail of the arrangement from FIG. 1 according to a first exemplary embodiment of the invention; and

FIG. 3 shows a detail of the arrangement from FIG. 1 according to a second exemplary embodiment of the invention.

### DETAILED DESCRIPTION OF THE PRESENTLY PREFERRED EMBODIMENTS

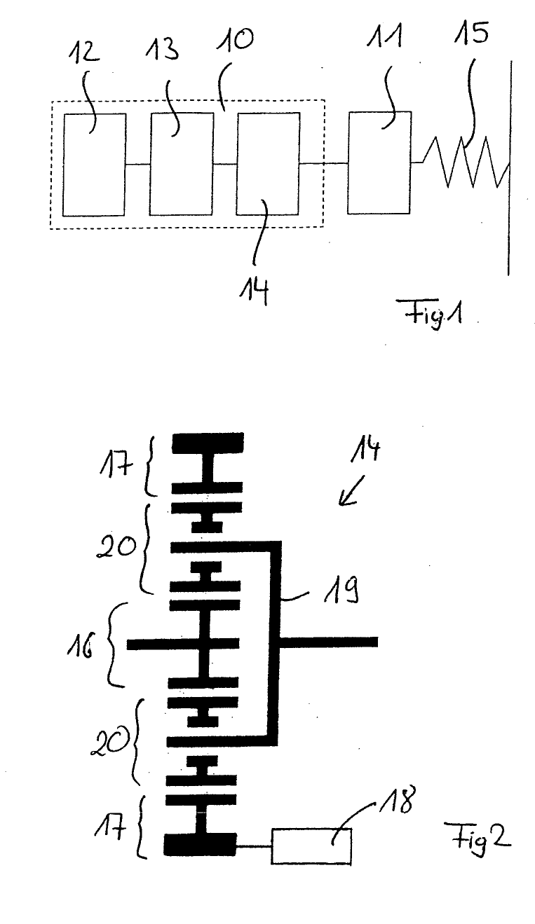

FIG. 1 shows a very diagrammatic illustration of an arrangement according to the invention including an electric actuator 10 and a device 11 which is to be actuated via the electric actuator 10. The electric actuator 10 according to the invention includes an electric-motor drive 12 which is preferably configured as a rapidly rotating electric motor of small size. The electric actuator 10 also includes a step-up gear mechanism 13, the electric-motor drive 12 inputting its drive into the step-up gear mechanism 13. With the aid of the step-up gear mechanism 13, the small torques which are made available at high rotational speeds by the electric-motor drive 12 are stepped up to large torques at low rotational speeds, in order to switch the device 11 between defined positions. Here, it is important or significant that, in the event of a failure of the current supply or voltage supply for the actuator 10, the device 11 assumes one of the defined positions or returns into a defined basic position or rest position.

Within the context of the present invention, the electric actuator 10 includes a clutch element 14 in addition to the electric-motor drive 12 and the step-up gear mechanism 13. The clutch element 14 is connected after the step-up gear mechanism 13 and is accordingly connected between the step-up gear mechanism 13 and the device 11 which is to be actuated. In the event of a failure of the current supply or voltage supply for the actuator 10, the clutch element 14 opens automatically and thus separates the step-up gear mechanism 13 from the device 11, with the result that the device 11 can assume the defined basic position or rest position via a restoring element which is configured as a spring element 15. Accordingly, in the event of a failure of the current supply or voltage supply for the actuator 10, the locking action of the step-up gear mechanism 13 is switched off by the opening of the clutch element 14, with the result that the device 11 can return into the defined basic position or rest position as a result of the restoring force provided by the spring element 15.

Although not shown in FIG. 1, what is known as an adaptation gear mechanism can be connected between the clutch element 14 and the device 11 which is to be actuated, which adaptation gear mechanism is distinguished by a low transmission ratio and accordingly has no locking action.

The clutch element 14 of the actuator according to the invention can be configured in a wide variety of ways. For instance, the clutch element 14 can be provided, for example, by a planetary gear mechanism. As an alternative, the clutch element 14 can be configured as a catch coupling, a multiple-disc clutch, an electric clutch or else a hydrodynamic clutch. The actuation of the clutch element 14 in the event of a failure of the current supply or voltage supply for the actuator 10 in order to decouple the step-up gear mechanism 13 from the device 11 according to the invention can take place hydraulically or electrically or magnetically or else electromagnetically within the context of the present invention.

In the exemplary embodiment of FIG. 2, the clutch element 14 is configured as a planetary gear mechanism, the electric-motor drive 12 inputting its drive via the step-up gear mechanism 13 into a sun gear 16 of the planetary gear mechanism. An internal gear 17 of the planetary gear mechanism is locked by a lifting magnet 18, the lifting magnet 18 acting as what is known as a locking pawl on the internal gear 17 of the planetary gear mechanism. The output from the planetary gear mechanism and accordingly the input into the device 11 which is to be actuated take place via a planetary carrier 19 from planetary gears 20 of the planetary gear mechanism 14. After a defined position for the device 11 has been assumed, the electric-motor drive 12 of the actuator 10 is switched off, as the position which is assumed by the device 11 can be held via the self-blocking or self-locking action of the step-up gear mechanism 13. For this purpose, current is applied only to the lifting magnet 18 which has a substantially smaller current consumption than the electric-motor drive 12.

In the event of a failure of the voltage supply or current supply for the actuator 10, the lifting magnet 18 releases the internal gear 17, as a result of which the device 11 can return into a basic position or rest position as a result of the spring force provided by the spring element 15. When the current supply is available again, current is applied again to the lifting magnet 18 and the internal gear 17 is rotated by the electric-motor drive 12 until the lifting magnet 18 locks the internal gear 17 of the planetary gear mechanism 14 again.

At this point, it is to be noted that the assignment of input, output and lifting magnet to the elements of the planetary gear mechanism, that is to say to sun gear, internal gear and planetary carrier, can be exchanged as desired.

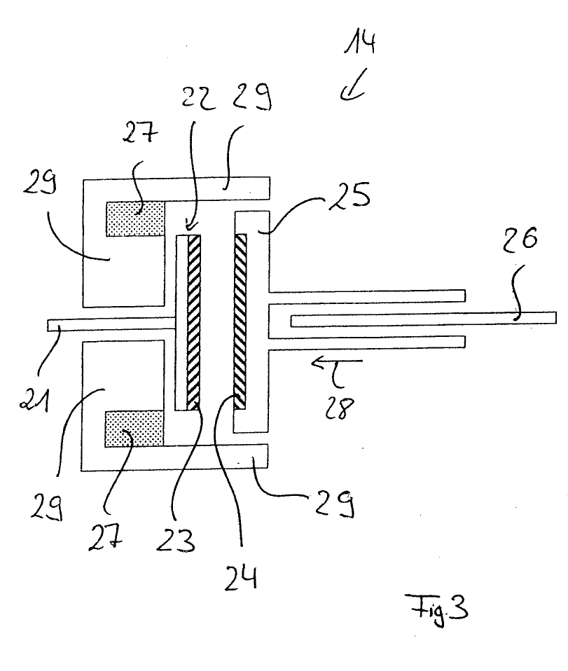

In the exemplary embodiment of FIG. 3, the clutch element 14 is configured as a catch coupling. In this exemplary embodiment, the electric-motor drive 12 of the actuator 10 according to the invention inputs its drive via the step-up gear mechanism 13 into an input shaft 21 of the clutch element 14 which is configured as a catch coupling, the input shaft 21 being connected to an input gear 22 which bears a toothing system 23. When the catch coupling 14 is closed, the toothing system 23 of the input gear 22 is in engagement with a toothing system 24 of an output gear 25, the output gear 25 being coupled to an output shaft 26.

When the catch coupling 14 is closed, a magnet coil 27 which is assigned to the catch coupling 14 has current supplied to it, in order to move or to pull the output gear 25 in the direction of the arrow 28 towards the input gear 22, and thus to bring the output gear 25 into engagement with the input gear 22. What is known as a driving toothing system is formed between the output gear 25 and the output shaft 26, with the result that the output gear 24 can move in the axial direction relative to the output shaft 26 and, nevertheless, remains in force-transmitting engagement with the output shaft 26.

In the event of a failure of the voltage supply or current supply for the actuator 10, current is not supplied further to the magnet coil 27. As a result, the output gear 25 is decoupled from the input gear 22 due to a slight oblique meshing of the toothing systems 23 and 24. Accordingly, in the event of a failure of the current supply or voltage supply for the actuator 10, the clutch element 14 of FIG. 3 is also opened automatically, in order thus to decouple the self-locking step-up gear mechanism 13 from the device 11 with the result that the device 11 can be transferred or returned into a defined position by the spring element 15.

In the exemplary embodiment shown in FIG. 3, the magnet coil 27 is integrated into a housing 29 of the clutch element 14. However, the positioning of the magnet coil 27 in the clutch element 14 can be varied, as long as a force-transmitting connection can be established between the toothing system 23 of the input gear 22 and the toothing system 24 of the output gear 25 only via the magnet coil 27. It is also possible to replace the magnet coil 27 with a lifting magnet which produces a force-transmitting connection between the input gear 22 and the output gear 25 indirectly via further mechanical components. Instead of a self-opening oblique toothing system between the input gear 22 and the output gear 25, a restoring spring can also be provided for the output gear 25. The drive side and the driven side of the clutch element 14 can be swapped or exchanged.

Clutch elements 14 which are configured as a planetary gear mechanism or as a catch coupling of the actuator 10 according to the invention have been described with reference to FIGS. 2 and 3. As has already been mentioned, the clutch element 14 of the actuator 10 according to the invention can also be configured as an electric clutch, as a hydrodynamic clutch or else as a multiple-disc clutch.

When the clutch element 14 is configured as a hydrodynamic clutch having a pump and a turbine, the electric-motor drive 12 of the actuator 10 according to the invention inputs its drive via the step-up gear mechanism 13 into the pump gear of the hydrodynamic clutch. The rotation of the pump gear of the hydrodynamic clutch produces a moment in the region of the turbine gear, which moment transfers the device 11 into the desired position. Once this desired position of the device 11 has been reached, the rotational speed of the electric-motor drive 12 of the actuator 10 is reduced until the drive 12 just holds the device 11 in the defined position counter to the spring force which is provided by the spring element 15.

However, if the current supply or voltage supply for the actuator 10 fails, the pump gear of the hydrodynamic clutch no longer produces any forward force on the turbine gear, and the turbine gear of the hydrodynamic clutch moves backwards as a result of the spring force which is provided by the spring element 15, until the device 11 which is to be actuated has assumed its defined basic position or rest position.

In the above-described exemplary embodiments for the clutch elements 14, the latter are actuated electrically, electromagnetically or magnetically. It is also possible to control the clutch elements 14 hydraulically, which is advantageous, in particular, in motor vehicles in which a hydraulic pressure is available in any case. In this case, the clutch element 14 of the actuator 10 according to the invention can be controlled by the hydraulic supply pressure in order to open or to close the clutch element 14. In the event of a failure of the current supply or voltage supply, the supply pressure also fails, with the result that the clutch element 14 can be decoupled from the device 11 so that the device 11 can be transferred into the basic position or rest position via the spring element 15.

The actuator according to the invention is used, in particular, where a device which is to be actuated is to be transferred between two switching positions. However, the actuator according to the invention can also be used in applications, in which the device can assume more than two switching positions, of which one is then considered to be a rest position or basic position which is to be assumed automatically in the event of a current failure.

The actuator according to the invention is preferably actuated by an electric controller which drives the electric-motor drive of the actuator in the respective direction when a switchover is required.

Here, the end of the switchover process can be stipulated by a time limit being reached or by the position of the device which is to be actuated being detected. Detailed sequences of the switching process can be stipulated by an electric controller which is based on a microcontroller.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. An electric actuator for a device which can be switched between at least two defined positions including a rest position, said actuator comprising:
an electric motor drive connected to a power supply and outputting torque at a rotational speed;
a step-up gear mechanism which increases the torque and reduces the rotational speed to a lower rotational speed, said step-up gear mechanism being connectable to the device to switch the device between said defined positions; and
a clutch element connected to the step-up mechanism so that the device can be driven at the lower rotational speed via the clutch element, said clutch element decoupling the step-up gear mechanism from the device in the event of a failure of the power supply to the electric motor drive, whereby the device can automatically assume the rest position in, the event of a failure of the power supply to the electric motor drive.

2. The electric actuator of claim 1 wherein the clutch element is actuated hydraulically in order to decouple it from the device in the event of a failure of the power supply to the electric motor drive.

3. The electric actuator of claim 1 wherein the clutch element is actuated electrically in order to decouple it from the device in the event of a failure of the power supply to the electric motor drive.

4. The electric actuator of claim 1 wherein the clutch element is actuated magnetically in order to decouple it from the device in the event of a failure of the power supply to the electric motor drive.

5. The electric actuator of claim 1 wherein the clutch element is actuated electromagnetically in order to decouple it from the device in the event of a failure of the power supply to the electric motor drive.

6. The electric actuator of claim 1 wherein the clutch element is configured as a planetary gear mechanism.

7. The electric actuator of claim 1 wherein the clutch element is configured as a hydrodynamic clutch.

8. The electric actuator of claim 1 wherein the clutch element is configured as a catch coupling.

9. The electric actuator of claim 1 wherein the clutch element is configured as a multiple disk clutch.

10. An actuation assembly comprising:
an electric motor drive connected to a power supply and outputting torque at a rotational speed;
a step-up gear mechanism which increases the torque and reduces the rotational speed to a lower rotational speed;
a device connected to the step-up gear mechanism so that the device can be switched between at least two defined positions including a rest position by said step-up gear mechanism; and
a clutch element between the step-up gear mechanism and the device, said clutch element decoupling the step-up gear mechanism from the device in the event of a failure of the power supply to the electric motor drive, whereby the device can automatically assume the rest position in the event of a failure of the power supply to the electric motor drive.

11. The actuation assembly of claim 10 further comprising a restoring element which switches the device to the rest position when the clutch element decouples the step-up gear mechanism from the device.

12. The actuation assembly of claim 11 when the restoring element is a spring.
